(19) United States
(12) Patent Application Publication
(10) Pub. No.: US 2026/0359782 A1
(43) Pub. Date: Nov. 12, 2026

(54) WAREHOUSE INFRASTRUCTURE

(71) Applicant: THREE SMITH GROUP LIMITED, Elland, Yorkshire (GB)

(72) Inventors: David Edgar, Upholland, Lancashire (GB); Milos Bozic, Huddersfield, Yorkshire (GB); Matthew Wroe, Leeds, Yorkshire (GB)

(73) Assignee: THREE SMITH GROUP LIMITED, Elland, Yorkshire (GB)

(21) Appl. No.: 19/121,549

(22) PCT Filed: Oct. 16, 2023
(86) PCT No.: PCT/EP2023/078680

§ 371 Date: Apr. 16, 2025

(30) Foreign Application Priority Data
Oct. 17, 2022 (GB) 2215292.0

(51) Int. Cl. G06Q 10/087; G06K 7/10

(52) U.S. Cl. CPC G06Q 10/08724; G06K 7/10297; G06K 7/10366

(57) ABSTRACT

An item of warehouse infrastructure comprising a controller and an RFID antenna. The controller is configured to: receive a motion-detection-signal from a sensor that is configured to detect movement in the vicinity of the item of warehouse infrastructure; and provide a trigger-signal when the motion-detection-signal indicates that movement is detected. The RFID antenna is configured to perform an RFID scan in response to the trigger-signal in order to: transmit an RFID-scanning-signal to excite one or more RFID tags in the vicinity of the RFID antenna; and provide RFID-signalling that is representative of one or more RFID-tag-signals received from one or more RFID tags. The controller is further configured to: process the RFID-signalling to determine one or more RFID-tag-identifiers associated with the RFID-signalling; and transmit an output-signal that is representative of the determined one or more RFID-tag-identifiers.

### FIELD

The present disclosure relates to items of warehouse infrastructure, an in particular to items of warehouse infrastructure that include an RFID antenna.

### SUMMARY

According to a first aspect of the present disclosure, there is provided an item of warehouse infrastructure comprising:
a controller that is configured to:
   receive a motion-detection-signal from a sensor that is configured to detect movement in the vicinity of the item of warehouse infrastructure; and
   provide a trigger-signal when the motion-detection-signal indicates that movement is detected;
an RFID antenna that is configured to perform an RFID scan in response to the trigger-signal in order to:
   transmit an RFID-scanning-signal to excite one or more RFID tags in the vicinity of the RFID antenna; and
   provide RFID-signalling that is representative of one or more RFID-tag-signals received from one or more RFID tags; and
wherein the controller is configured to:
   process the RFID-signalling to determine one or more RFID-tag-identifiers associated with the RFID-signalling; and
   transmit an output-signal that is representative of the determined one or more RFID-tag-identifiers.

Advantageously, such an item of warehouse infrastructure can be operated in an efficient way, in terms of power consumption, because the RFID antenna is controlled such that it performs an RFID scan at times when it is most likely that there has been a change in the RFID tags that are near the item of warehouse infrastructure.

The controller may be configured to:
process the determined one or more RFID-tag-identifiers associated with the RFID-signalling in order to identify RFID-tag-identifiers that are associated with warehouse stock; and
transmit an output-signal that is representative of only the RFID-tag-identifiers that are identified as being associated with warehouse stock.

The controller may be configured to:
compare the determined one or more RFID-tag-identifiers with one or more RFID-tag-identifiers that were determined from an earlier RFID scan; and
transmit an output-signal that is representative of the determined one or more RFID-tag-identifiers only if there has been a change in the determined RFID-tag-identifiers from the earlier RFID scan.

The controller may be configured to postpone providing the trigger signal to the RFID antenna until a predetermined period of time after the motion was detected has elapsed.

The controller may be configured to provide the trigger signal to the RFID antenna after a detected movement has stopped.

The item of warehouse infrastructure may be a post, a barrier, a racking leg, a post-cap, a gate post, or a shelf.

The item of warehouse infrastructure may further comprise the sensor that is configured to detect movement in the vicinity of the item of warehouse infrastructure. The item of warehouse infrastructure may be battery powered.

The controller may be further configured to:
cause the RFID antenna to perform an RFID scan periodically or in response to a user-initiated trigger-signal.

There is also provided a stock monitoring system comprising:
any item of warehouse infrastructure disclosed herein, wherein the output-signal that is transmitted by the item of warehouse infrastructure includes an infrastructure-identifier;
a server that is configured to:
   receive the output-signal from the item of warehouse infrastructure;
   determine a location of the item of warehouse infrastructure based on the infrastructure-identifier in the received output-signal; and
   generate a map of the warehouse that includes the determined location of the item of warehouse infrastructure along with a representation of the one or more RFID-tag-identifiers in the output-signal.

The stock monitoring system may further comprise:
one or more additional items of warehouse infrastructure, wherein the output-signal that is transmitted by each of the one or more additional items of warehouse infrastructure includes an infrastructure-identifier; and
wherein the server is configured to:
   also receive the output-signals from the one or more additional items of warehouse infrastructure;
   determine the location of each of the one or more additional items of warehouse infrastructure based on the infrastructure-identifier in the respective output-signals;
   for any RFID-tag-identifiers that are represented by a plurality of the output-signals, determine a stock-location for the RFID-tag-identifier by combining the determined locations of the items of warehouse infrastructure that provided the plurality of output-signals; and
   generate the map of the warehouse such that it includes the determined stock-locations along with the associated RFID-tag-identifiers.

The server may be configured to:
determine the stock-location for the RFID-tag-identifier by averaging the determined locations of the items of warehouse infrastructure that provided the plurality of output-signals.

The server may be configured to:
determine the stock-location for the RFID-tag-identifier by using a predetermined relationship between the stock-location and the determined locations of the items of warehouse infrastructure that provided the plurality of output-signals.

The server may be configured to determine the stock-location as one of a plurality of
predetermined candidate-stock-locations that represent stock storage regions in the warehouse.

According to a further aspect of the present disclosure, there is provided a method of scanning a warehouse, the method comprising:
receiving a motion-detection-signal from a sensor that is configured to detect movement in the vicinity of the item of warehouse infrastructure; and
providing a trigger-signal when the motion-detection-signal indicates that movement is detected;
performing an RFID scan in response to the trigger-signal by:
   transmitting an RFID-scanning-signal to excite one or more RFID tags in the vicinity of the RFID antenna; and
   providing RFID-signalling that is representative of one or more RFID-tag-signals received from one or more RFID tags;
processing the RFID-signalling to determine one or more RFID-tag-identifiers associated with the RFID-signalling; and
transmitting an output-signal that is representative of the determined one or more RFID-tag-identifiers.

There may be provided a computer program, which when run on a computer, causes the computer to configure any apparatus, including a controller, system or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 shows schematically a plan view of part of the inside of a warehouse;

FIG. 2 shows a region in a warehouse in which two items of warehouse infrastructure according to the present disclosure are present;

FIG. 3 shows a post of FIG. 2 in more detail, along with three items of nearby stock; and

FIG. 4 shows an example embodiment of a stock monitoring system according to the present disclosure.

### DETAILED DESCRIPTION

It can be difficult to keep track of stock in a warehouse, especially a very large warehouse. Also, in some circumstances, containers that store multiple items of stock (such as totes, boxes or pallets) can accumulate in certain areas of a warehouse and it can be difficult to identify that this is happening and where it is happening.

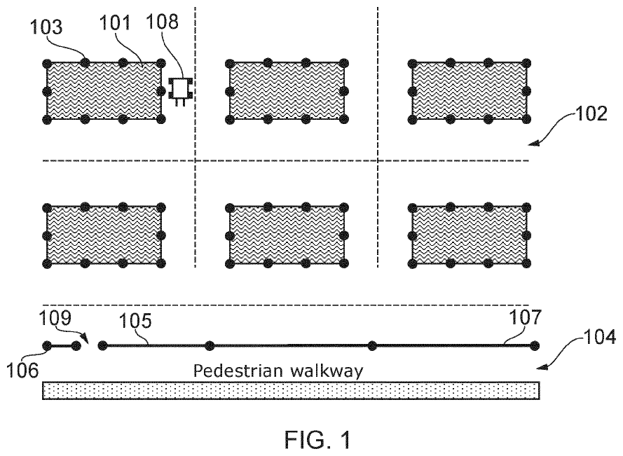

FIG. 1 shows schematically a plan view of part of the inside of a warehouse, which is a suitable environment in which an item of warehouse infrastructure that is described herein can be used. FIG. 1 shows six banks of racking 101, with aisles 102 in between each bank 101. As shown in FIG. 1, a forklift truck (FLT) 108 can drive along the aisles in order to access stock that is stored in different banks of racking 101. Each bank of racking 101 has a plurality of racking legs 103. A racking leg 103 is a vertical support that is used to support shelving or pallets. The banks of racking 101 can also include beams (that are generally horizontal) and/or braces (that extend generally diagonally with reference to the ground).

FIG. 1 also shows that a part of the warehouse is designated as a pedestrian walkway 104. The pedestrian walkway 104 is separated from an end aisle of racking by a barrier 105. In this example, the barrier 105 is shown as including a plurality of spaced apart posts 106, with rails 107 joining the majority of the adjacent posts 106. A pedestrian access point 109 is shown as a gap in the barrier, through which a pedestrian can walk to move between the pedestrian walkway 104 and a part of the warehouse in which the FLT 108 operates.

Each of the posts 106, barriers 105, racking legs 103, and banks of racking 101 are examples of items of warehouse infrastructure according to the present disclosure. Additionally, one or mor of the following can also be considered as items of warehouse infrastructure: a post-cap (that is, a cap on a post), a gate post, a shelf, and any other barrier or divider between different areas in a warehouse (including barriers between different stock storage areas).

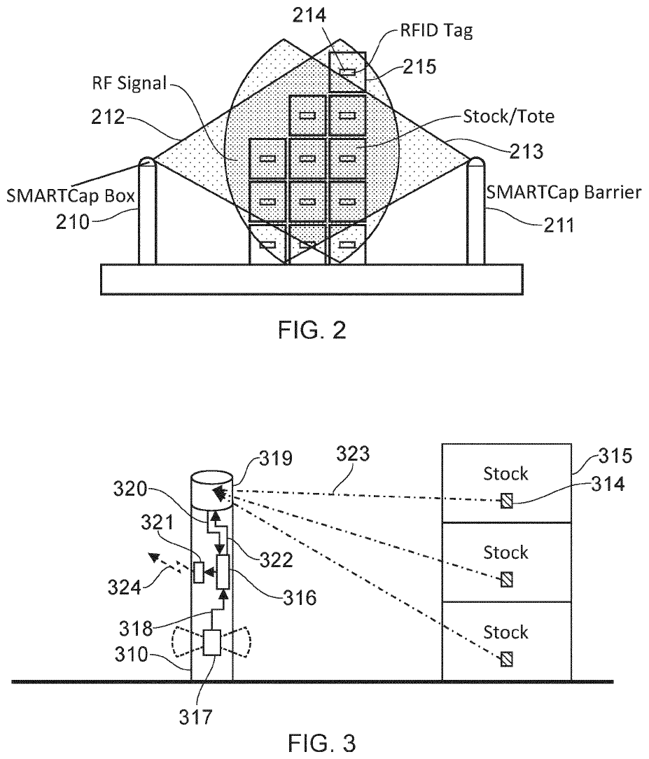

FIG. 2 shows a region in a warehouse in which two items of warehouse infrastructure according to the present disclosure are present. In this example, the items of warehouse infrastructure are a first post 210 and a second post 211. As will be discussed below, especially with reference to FIG. 3, the first and second posts 210, 211 include a controller and an RFID antenna. The controllers and the RFID antennas can be located in any desired location with respect to their respective posts 210, 211. In an example where the controller and the RFID antenna are located in a cap portion of the post 210, 211 (which in some implementations can be provided as a separate component to the post 210, 211 such that it can be fitted onto the post), the item of warehouse infrastructure that includes the controller and the RFID antenna can be considered as a post cap.

As will be discussed in detail below with reference to FIG. 3, the RFID antennas of the first and second posts 210, 211 transmit RFID-scanning-signals 212, 213 to excite one or more RFID tags 214 in the vicinity of the RFID antennas. In this example, the RFID tags 214 are associated with items of stock 215 in the warehouse. Each RFID tag 214 may be associated with an individual item of stock 215, or it may be associated with a container that stores multiple items of stock such as a tote, a box or a pallet.

FIG. 3 shows a post 310 of FIG. 2 in more detail, along with three items of nearby stock 315. Each item of stock 315 has an associated RFID tag 314.

As indicated above, the post 310 includes a controller 316 and an RFID antenna 319. In this example, the post 310 also has a transmitter 321 and a sensor 317 for detecting movement in the vicinity of the post 310.

The controller 316 is configured to receive a motion-detection-signal 318 from the sensor 317. As non-limiting examples, the sensor 317 can be implemented as a vibration sensor, a passive infra-red (PIR) sensor, a pressure sensor (which may be implemented on a shelf that receives stock, for example), or any other type of sensor that can detect movement in the vicinity of the post 310. As will be appreciated from the description that follows, such a detected movement can be considered as an indicator that the stock 315 in the vicinity of the post 310 may have moved.

The controller 316 provides a trigger-signal 322 to the RFID antenna 319 when the motion-detection-signal 318 indicates that movement is detected. The RFID antenna then performs an RFID scan in response to the trigger-signal 322. The RFID scan comprises the RFID antenna 319 transmitting an RFID-scanning-signal (not shown in FIG. 3 so as not to obscure the other features of the drawing) in order to excite one or more RFID tags 314 in the vicinity of the RFID antenna 319. Any RFID tags 314 that are excited by the RFID-scanning-signal transmit an RFID-tag-signal 323 in response to the excitation, as is known in the art. In this example the RFID tags 314 are passive, which is advantageous because batteries do not have to be provided for the stock 315 and therefore there is no need to periodically recharge or replace any such batteries. Furthermore, the RFID tags 314 in this example are ultra high frequency (UHF) tags.

The RFID antenna 319 then provides RFID-signalling 320 that is representative of one or more RFID-tag-signals 323 received from one or more RFID tags 314 following excitation by the RFID-scanning-signal.

The controller 316 processes the RFID-signalling 320 to determine one or more RFID-tag-identifiers associated with the RFID-signalling 323 and transmits an output-signal 324 that is representative of the determined one or more RFID-tag-identifiers. In this example, the post 310 includes a transmitter 321 for transmitting the output-signal 324 to a remote device such as a server.

Advantageously, the post 310 of FIG. 3 can be operated in an efficient way, in terms of power consumption, because the RFID antenna 319 is controlled such that it performs an RFID scan at times when it is most likely that there has been a change in the RFID tags 314 (and therefore also a change in the stock 315) that is near the post 310. For example, the sensor 317 can detect when a FLT is near the post 310 because it is removing stock 315 from, or adding stock 315 to, a storage bay that is near the post 310 and in response a RFID scan can be performed to check if any stock has been moved.

In some examples, the controller 316 can postpone providing the trigger signal 322 to the RFID antenna 319 until a predetermined period of time after the motion was detected has elapsed. This can enable any stock movement operations to be completed before the RFID scan is performed, and therefore a minimum number of (power-consuming) RFID scans that are required to detect the change in stock can be performed. In another example, the controller 316 can provide the trigger signal 322 to the RFID antenna 319 after a detected movement has stopped. Again, such an example can increase the likelihood that the RFID scan detects the change in stock 315 and reduces the likelihood that the RFID scan is performed prematurely.

The energy efficient implementations of the post 310 that are described above advantageously enable the post 310 to be battery powered, and for the time between battery replacement or recharging to be kept at a relatively long time. This is a very significant benefit in a warehouse environment where mains electricity may not be directly available at every item of warehouse infrastructure and/or it may be desirable to move or replace items of warehouse infrastructure without having to worry about changing the electrical wiring.

In one implementation, the controller 316 determines that an RFID-tag-signal 323 is present in the RFID-signalling 320 only if the RFID-tag-signal 323 has a signal strength that is greater than a threshold value. One example of how the signal strength can be represented is a Received Signal Strength Indicator (RSSI) for the received RFID-tag-signals 323. In this way, weak RFID-tag-signals 323, perhaps because they are too far away to be considered in the vicinity of the post 310, can be excluded from further processing and omitted from the output-signal 324.

In some examples, the controller 316 can process the determined one or more RFID-tag-identifiers associated with the RFID-signalling 320 in order to identify RFID-tag-identifiers that are associated with warehouse stock 315. For example, the controller 316 may have access to a look-up-table or database in computer memory that stores a list of RFID-tag-identifiers that are associated with warehouse stock 315. Such a look-up table or database may also include RFID-tag-identifiers that are not associated with stock; for example they may instead be associated with items of infrastructure or items of clothing such as PPE (personal protective equipment). The controller 316 can then transmit an output-signal 324 that is representative of only the RFID-tag-identifiers that are identified as being associated with warehouse stock 315.

Such an implementation represents an effective way of determining the location of stock 315 (potentially the location of stock-carrying totes, pallets and boxes, depending upon how the RFID tags 314 are used) in the warehouse. Depending upon the location of the post 310 in FIG. 3 (and any other items of warehouse infrastructure that have the same functionality as the post 310 in FIG. 3), the location of stock 315 can be determined as it enters/leaves the warehouse, when it enters/leaves temporary holding locations in the warehouse, and/or when it is in transit between such locations. Furthermore, as indicated above, such location determination can be performed in an energy efficient way because RFID scans are performed in response to detected movements that will occur when stock 315 is being moved in the warehouse in the this way.

In some examples, the controller 316 can compare the determined one or more RFID-tag-identifiers with one or more RFID-tag-identifiers that were determined from an earlier RFID scan (in some examples the immediately previous RFID scan). In this way, the controller 316 can determine if there has been a change in the RFID-tag-identifiers that are in the vicinity of the post 310. The change can be the appearance of a new RFID-tag-identifier and/or the disappearance of an RFID-tag-identifier. The controller 316 can then transmit an output-signal 324 that is representative of the determined one or more RFID-tag-identifiers only if there has been a change in the determined RFID-tag-identifiers from the earlier RFID scan. In some implementations, the output-signal 324 may represent only the change in the determined one or more RFID-tag-identifiers. In another example, the controller 316 can transmit an output-signal 324 that is representative of the determined one or more RFID-tag-identifiers only if the determined RFID-tag-identifiers for the current RFID scan differ from the determined RFID-tag-identifiers in the earlier RFID scan by at least a minimum amount (for example there are at least a threshold number of different RFID-tag-identifiers that are returned by the scans, where the threshold number may be 1, 2, 3, or more). In this way, the controller 316 will only send the update information (e.g. to a server) once a certain degree of movement has taken place; e.g., at least 3 box movements. This is advantageous if the RFID antenna 319 is scanning an area with a very high movement of goods, and is for an application that is more interested in how many items (such as totes, boxes, etc.) are standing still, because battery power is not consumed by sending updates that are not required for the particular application. Such implementations can represent yet further energy saving processes that are performed by the controller 316 because output-signals 324 are not transmitted if they do not represent any new information or insufficient new information to warrant the transmission of an output-signal. This still further assists in extending the battery life of the post 310 if it is battery powered.

In some examples, the functionality of one or more of the items of warehouse infrastructure that are disclosed herein can be extended by the controller 316 also, or alternatively, causing the RFID antenna 319 to perform an RFID scan periodically or in response to a user-initiated trigger-signal. In this way, RFID-signalling 320 can be provided by the RFID antenna 319 on demand or at least with a minimum time interval between consecutive RFID scans.

In a yet further example, once movement has been detected and the RFID antenna 319 has performed an RFID scan, the controller 316 can wait for a minimum period of time to expire before it provides another trigger-signal 322 to the RFID antenna 319 (even if motion is detected by the sensor 317 in this period of time). In this way, a minimum wait time is implemented between successive RFID scans. Advantageously, this can reduce the number of output-signals that are transmitted and can conserve battery power. This can be particularly useful in applications that are more interested in stock than flow/movement of stock.

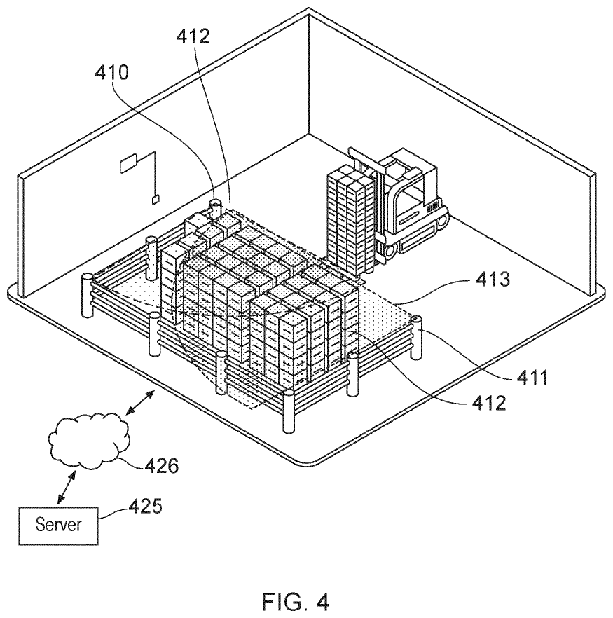

FIG. 4 shows an example embodiment of a stock monitoring system according to the present disclosure. The stock monitoring system includes a server 425 one or more items of warehouse infrastructure (in this example at least two posts 410, 411).

FIG. 4 shows a region of a warehouse that includes eight posts, and seven barriers between the posts, that define a stock storage region in the warehouse. RFID-scanning-signals 412, 413 are shown in FIG. 4 as being emitted from two of the posts 410, 411. However, it will be appreciated that any of the other posts and/or any of the barriers can also include an RFID scanner such that they can also emit RFID-scanning-signals in the same way that is described above with respect to FIG. 3, and therefore they can each also generate output-signals that are representative of one or more RFID-tag-identifiers that are associated with nearby stock 415. In this example, each of the output-signals includes an infrastructure-identifier that is a unique identifier for the item of warehouse infrastructure 410, 411 that provided the output-signal.

As will now be described, the server 425 can process the output-signals received from a plurality of items of warehouse infrastructure 410, 411 (in this example received over a network such as the internet 426) in order to generate map of the warehouse that includes the location of stock that is associated with detected RFID tags.

The server 425 receives an output-signal from one or more of the items of warehouse infrastructure 410, 411 and can determine a location of the item of warehouse infrastructure associated with each output-signal based on the infrastructure-identifier in the respective output-signal. In some examples, this can involve the server 425 using a look-up table or a database to determine coordinates of the item of infrastructure 410, 410 using the infrastructure-identifier.

The server 425 can then generate a map of the warehouse that includes the determined locations of each of the items of warehouse infrastructure 410, 411 along with a representation of the one or more RFID-tag-identifiers in the output-signal that is associated with each item of warehouse infrastructure 41, 411. The representation of the one or more RFID-tag-identifiers can be provided in any convenient way. For example, a name of the type of stock that is associated with an RFID-tag-identifier can be displayed along with a count of the number of stock that has been detected by an individual item of warehouse infrastructure 410, 411.

In some applications, an RFID-tag-identifiers may be represented by output-signals received from a plurality of items of warehouse infrastructure. This is indicated schematically in FIG. 4 where it can be seen that some (if not all) of the stock 415 is exposed to both an RFID-scanning-signals 412 from a first post 410 and is also exposed to an RFID-scanning-signal 413 from a second post 411. In which case, the server 425 can determine a stock-location for the RFID-tag-identifier by combining the determined locations of the items of warehouse infrastructure 410, 411 that provided the output-signals that included the same RFID-tag-identifier. Following which, the server 425 can generate a map of the warehouse such that it includes the determined stock-locations along with a representation of the associated RFID-tag-identifiers.

In one implementation, the server 425 can determine the stock-location for the RFID-tag-identifier by averaging the determined locations of the items of warehouse infrastructure that provided the plurality of output-signals. In this way, the stock-location can be determined as the mid-point between the items of warehouse infrastructure that detected the RFID tags associated with the stock.

In another implementation, the server 425 can determine the stock-location for the RFID-tag-identifier by using a predetermined relationship between the stock-location and the determined locations of the items of warehouse infrastructure that provided the plurality of output-signals. For instance, the server 425 may have access to computer memory that stores an association between known stock storage regions and associated items of warehouse infrastructure that are near the stock storage regions. In this way, the server 425 can determine the stock-location as one of a plurality of predetermined candidate-stock-locations that represent stock storage regions in the warehouse.

1. An item of warehouse infrastructure, comprising:
a controller that is configured to:
receive a motion-detection-signal from a sensor that is configured to detect movement in a vicinity of the item of warehouse infrastructure; and
provide a trigger-signal when the motion-detection-signal indicates that movement is detected; and
an RFID antenna that is configured to perform an RFID scan in response to the trigger-signal in order to:
transmit an RFID-scanning-signal to excite one or more RFID tags in a vicinity of the RFID antenna; and
provide RFID-signalling that is representative of one or more RFID-tag-signals received from one or more RFID tags; and
wherein the controller is configured to:
process the RFID-signalling to determine one or more RFID-tag-identifiers associated with the RFID-signalling; and
transmit an output-signal that is representative of the determined one or more RFID-tag-identifiers.

2. The item of warehouse infrastructure of claim 1, wherein the controller is configured to:
process the determined one or more RFID-tag-identifiers associated with the RFID-signalling in order to identify RFID-tag-identifiers that are associated with warehouse stock; and
transmit an output-signal that is representative of only the RFID-tag-identifiers that are identified as being associated with warehouse stock.

3. The item of warehouse infrastructure of claim 1, wherein the controller is configured to:
compare the determined one or more RFID-tag-identifiers with one or more RFID-tag-identifiers that were determined from an earlier RFID scan; and
transmit an output-signal that is representative of the determined one or more RFID-tag-identifiers only if there has been a change in the determined RFID-tag-identifiers from the earlier RFID scan.

4. The item of warehouse infrastructure of claim 1, wherein the controller is configured to postpone providing the trigger signal to the RFID antenna until a predetermined period of time after the motion was detected has elapsed.

5. The item of warehouse infrastructure of claim 1, wherein the controller is configured to provide the trigger signal to the RFID antenna after a detected movement has stopped.

6. The item of warehouse infrastructure of claim 1, wherein the item of warehouse infrastructure is a post, a barrier, a racking leg, a post-cap, a gate post, or a shelf.

7. The item of warehouse infrastructure of claim 1, further comprising the sensor that is configured to detect movement in the vicinity of the item of warehouse infrastructure.

8. The item of warehouse infrastructure of claim 1, wherein the item of warehouse infrastructure is battery powered.

9. The item of warehouse infrastructure of claim 1, wherein the controller is further configured to:
cause the RFID antenna to perform an RFID scan periodically or in response to a user-initiated trigger-signal.

10. A stock monitoring system, comprising:
an item of warehouse infrastructure according to any preceding claim, wherein the output-signal that is transmitted by the item of warehouse infrastructure includes an infrastructure-identifier; and
a server that is configured to:
receive the output-signal from the item of warehouse infrastructure;
determine a location of the item of warehouse infrastructure based on the infrastructure-identifier in the received output-signal; and
generate a map of the warehouse that includes the determined location of the item of warehouse infrastructure along with a representation of the one or more RFID-tag-identifiers in the output-signal.

11. The stock monitoring system of claim 10, further comprising:
one or more additional items of warehouse infrastructure according to claim 1, wherein the output-signal that is transmitted by each of the one or more additional items of warehouse infrastructure includes an infrastructure-identifier; and
wherein the server is configured to:
also receive the output-signals from the one or more additional items of warehouse infrastructure;
determine the location of each of the one or more additional items of warehouse infrastructure based on the infrastructure-identifier in the respective output-signals;
for any RFID-tag-identifiers that are represented by a plurality of the output-signals, determine a stock-location for the RFID-tag-identifier by combining the determined locations of the items of warehouse infrastructure that provided the plurality of output-signals; and
generate the map of the warehouse such that it includes the determined stock-locations along with the associated RFID-tag-identifiers.

12. The stock monitoring system of claim 11, wherein the server is configured to:
determine the stock-location for the RFID-tag-identifier by averaging the determined locations of the items of warehouse infrastructure that provided the plurality of output-signals.

13. The stock monitoring system of claim 11, wherein the server is configured to:
determine the stock-location for the RFID-tag-identifier by using a predetermined relationship between the stock-location and the determined locations of the items of warehouse infrastructure that provided the plurality of output-signals.

14. The stock monitoring system of claim 13, wherein the server is configured to determine the stock-location as one of a plurality of predetermined candidate-stock-locations that represent stock storage regions in the warehouse.

15. A method of scanning a warehouse, the method comprising:
receiving a motion-detection-signal from a sensor that is configured to detect movement in a vicinity of an item of warehouse infrastructure; and
providing a trigger-signal when the motion-detection-signal indicates that movement is detected;
performing an RFID scan in response to the trigger-signal by:
transmitting an RFID-scanning-signal to excite one or more RFID tags in a vicinity of an RFID antenna; and
providing RFID-signalling that is representative of one or more RFID-tag-signals received from one or more RFID tags;
processing the RFID-signalling to determine one or more RFID-tag-identifiers associated with the RFID-signalling; and
transmitting an output-signal that is representative of the determined one or more RFID-tag-identifiers.
